(19) United States
(12) Patent Application Publication
(10) Pub. No.: US 2004/0128917 A1
(43) Pub. Date: Jul. 8, 2004

(54) Trim door hardware carrier and method of assembling vehicle door

(76) Inventors: Jin Cheng Lin, Farmington Hills, MI (US); Dennis John Buening, Northville, MI (US); Radoslav Bokun, Windsor (CA); Manfred Fritsch, Highland, MI (US); David J. Krysiak, Pleasant Ridge, MI (US); Daniel E. Wenglinski, Taylor, MI (US); Juliusz Kirejczyk, Newmarket (CA); Luc R. Regnier, Toronto (CA); David Legault, Windsor (CA); Douglas G. Broadhead, Brampton (CA)

Correspondence Address: Robin W. Asher, Clark Hill PLC, Suite 3500, 500 Woodward Avenue, Detroit, MI, 48226-3435, US

(21) Appl. No.: 10/616,120

(22) Filed: Jul. 3, 2003

Related U.S. Application Data
(63) Continuation-in-part of application No. PCT/CA03/00040, filed on Jan. 7, 2003.

(51) Int. Cl. E05F 11/38

(52) U.S. Cl. 49/502; 49/348; 49/352

(57) ABSTRACT

A method for assembling a motor vehicle door includes the steps of affixing a plurality of hardware components to a secondary trim component to form a door module assembly. The door module assembly is attached to the structural door body. A trim panel is secured to the structural door body overlaying the door module assembly. The secondary trim component has a map pocket wall and the trim panel has a map pocket opening. When the trim panel overlays the secondary trim component, the trim panel cooperates with the secondary trim component to define a map pocket.

### FIELD OF THE INVENTION

This invention relates to a door module assembly for a motor vehicle door. More particularly, the invention relates to a method for assembling a motor vehicle door that utilizes a trim panel component as a structural carrier for a door module assembly.

### DESCRIPTION OF RELATED ART

A motor vehicle door typically includes a structural door body having an outer sheet metal panel and an inner sheet metal panel, a plurality of hardware components mounted within an inner cavity formed between the outer and inner sheet metal panels, and an interior trim panel. The complete assembly of the door involves multiple manufacturing steps and numerous parts. Conventionally, an original equipment manufacturer (OEM) will install each individual hardware component and the trim panel to the structural door body along an assembly line.

The conventional installation of the hardware components has, however, several drawbacks. First, a high assembly cycle time is required to assemble the door in this fashion since installation of each hardware component is a separate task requiring human effort. Second, operability of the hardware components cannot be determined until the respective components are installed onto the door. Thus, time and labor may be wasted installing inoperable components. Finally, additional time is required to inventory each hardware component as it arrives at the OEM to ensure that all of the hardware components are available for assembly.

Pre-assembled door modules have been proposed to overcome the deficiencies of conventional door assembly methods. A door module typically involves utilizing a structural carrier member to partially assemble and orient hardware components thereto prior to installation to the structural door body. One disadvantage associated with such door modules is that once the door module is installed to the door, the structural carrier member serves little or no purpose since all of the hardware components are eventually securely fastened to the structural door body.

U.S. Pat. No. 6,148,564 discloses one example of a vehicle door module. A motor vehicle door includes an inner panel having an aperture. A door module is mounted on the inner panel. The door module includes an X-shaped structural member having a central portion and arms extending therefrom. A free end of each arm is secured to the inner panel. The door module also includes a support panel, which is secured to the structural member and to the inner panel. Various door components, including a window lift mechanism, an electric motor, and a door latch handle, are mounted on the support panel and the structural member. The door module can be preassembled before mounting on the inner panel. The structural member of the module serves, however, no purpose once the module is mounted along the inner panel.

Thus, there remains a need for a door module that is assembled entirely from existing door components.

### SUMMARY OF THE INVENTION

The disadvantages of the related art may be overcome by providing a method for manufacturing a motor vehicle door utilizing a door module assembly including a trim panel component and a plurality of hardware components secured thereto prior to assembly to a structural door body of the door.

According to one aspect of the invention there is provided a method for assembling a motor vehicle door. The method includes the steps of affixing a plurality of hardware components to a secondary trim component to form a door module assembly. The door module assembly is attached to the structural door body. A trim panel is secured to the structural door body overlaying the door module assembly. The secondary trim component has a map pocket wall and the trim panel has a map pocket opening. When the trim panel overlays the secondary trim component, the trim panel cooperates with the secondary trim component to define a map pocket.

According to another aspect of the invention, there is provided a door module assembly. The door module assembly comprises a trim panel having a map pocket opening and a secondary trim component having a map pocket wall. A plurality of door hardware components are affixed to the secondary trim component. The trim panel cooperates with the secondary trim component to define a map pocket when the trim panel overlays the secondary trim component.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is an exploded, perspective view of a motor vehicle door including a door module assembly according to a first embodiment of the invention;

FIG. 2 is a front view of the door module assembly according to the first embodiment;

FIG. 3 is a rear view of the door module assembly according to the first embodiment;

FIG. 4 is a front view of an inner sheet metal layer of the motor vehicle door including access holes for receiving the door module assembly according to the first embodiment;

FIG. 5 is a front view of the inner sheet metal layer having the door module assembly secured thereto according to the first embodiment; and

FIG. 6 is a rear view of a trim panel for affixing to the motor vehicle door according to the first embodiment.

FIGS. 7A and 7B are front and rear views, respectively, of a secondary trim component according to a second embodiment of the invention;

FIG. 8 is a front view of a vehicle structural door body onto which the secondary trim component is installed, according to the second embodiment;

FIG. 9 is a front view of a partially assembled vehicle door according to the second embodiment;

FIG. 10 is a front view of an assembled vehicle door according to the second embodiment;

FIG. 11 is a side view of a transport unit for shipping the parts composing a door module assembly of the second embodiment;

FIG. 12 shows front views of the secondary trim component and a lower trim panel of the door module assembly according to the second embodiment;

FIGS. 13A-13C are perspective views illustrating various steps in assembling the vehicle door according to the second embodiment;

FIG. 14 is a detail view of a strap connector;

FIGS. 15A-15C are detailed perspective views illustrating various steps in mounting a latch onto the vehicle door according to the second embodiment;

FIG. 16A is a second perspective view of the lower trim panel of the second embodiment, taken in isolation;

FIG. 16B is a perspective view of an upper trim panel of the second embodiment, taken in isolation;

FIG. 16C is partial, detailed cross-sectional view of a panel locating structure; and

FIG. 17 is a partial, detailed cross-sectional view of a panel fastening structure.

### DETAILED DESCRIPTION OF THE PREFERRED EMBODIMENT

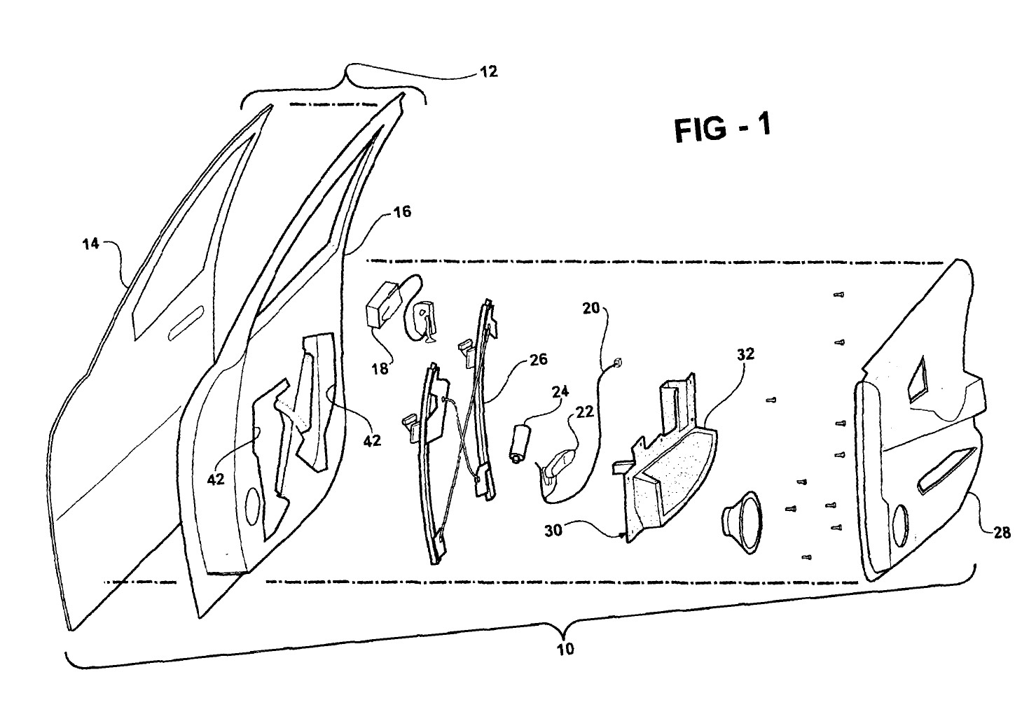

Referring to FIG. 1, a motor vehicle door, generally shown at 10, includes a structural door body 12 having outer 14 and inner 16 sheet metal layers. A plurality of hardware components, including a power lock actuator and lock assembly 18, an inside release cable 20, an inside release handle 22, an electric motor 24, and a window regulator 26, are positioned between the outer 14 and inner 16 sheet metal layers when the door 10 is fully assembled.

A trim panel 28 is secured to and extends over the inner sheet metal layer 16 to provide an aesthetically pleasing appearance to a motor vehicle occupant. The trim panel 28 is generally formed by a molding process, as is commonly known to one of ordinary skill in the art. Specific reference is made to U.S. Pat. Nos. 5,387,390; 5,397,409; 5,571,355; 5,885,662; 6,013,210; and 6,017,617. Trim panel 28 is contoured in the lower region to present a map pocket region. At the upper edge of this region, a map pocket opening 29 is provided. The opening 29 can be formed during the molding process or cut or trimmed after molding.

A secondary trim component, generally indicated at 30, of the trim panel 28 is formed separately therefrom. In a preferred embodiment, the secondary trim component 30 is a map pocket component 32. In this case, the map pocket component 32 is formed as a relatively rigid piece separate from the trim panel 28. After complete assembly of the door 10, the map pocket component 32 is accessible to a motor vehicle occupant for storage of items.

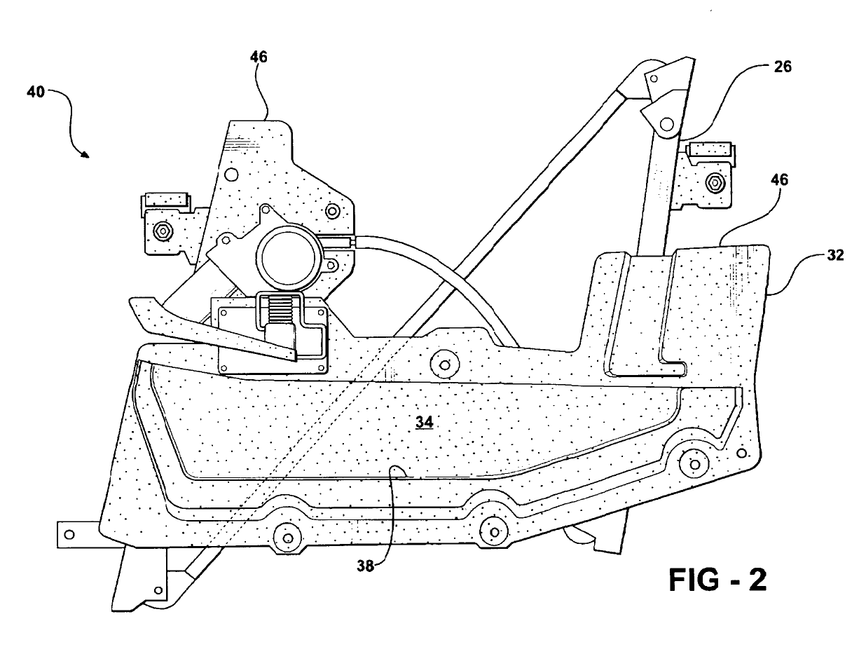

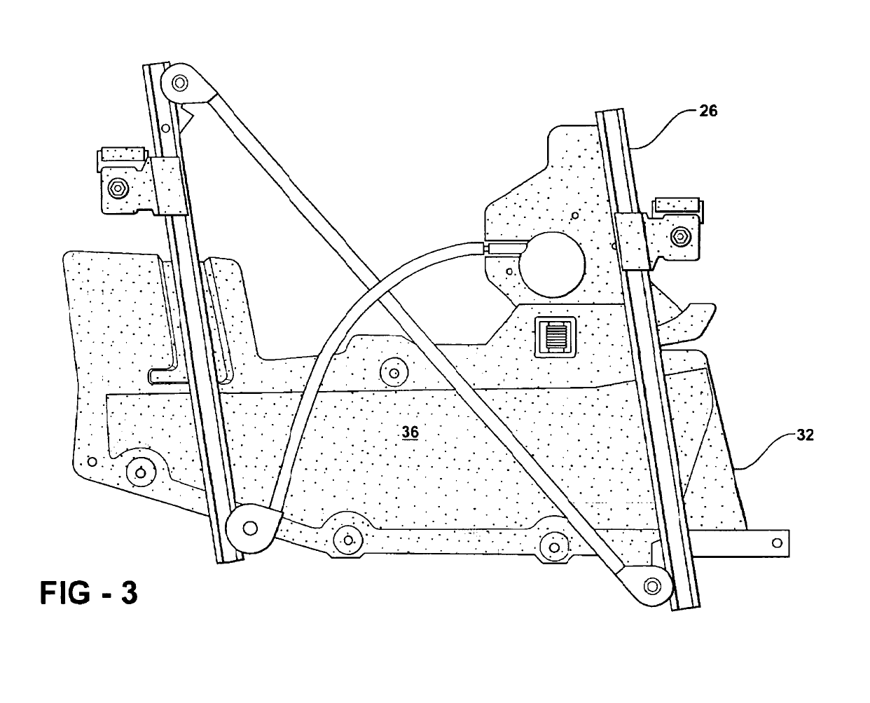

Referring to FIGS. 2 and 3, the map pocket component 32 has an inboard surface 34 facing away from the outer sheet metal layer 14 (FIG. 2), and an outboard surface 36 facing the outer sheet metal layer 14 (FIG. 3). A U-shaped pocket wall or shelf structure 38 is formed along the inboard surface 34. Each of the plurality of hardware components is individually secured to the map pocket component 32 along the outboard surface 36 thereof to form a door module assembly, generally shown at 40. The door module assembly 40 is assembled away from the rest of the motor vehicle door 10. Since the map pocket component 32 is relatively rigid, the map pocket component 32 provides structural integrity for the door module assembly 40. This structural integrity is sufficient for transport from a secondary assembly plant, where the door module assembly 40 is assembled, to an original equipment manufacturer (OEM), where the door module assembly 40 is mounted to the inner sheet metal layer 16.

As the hardware components are secured to the map pocket component 32 to form the door module assembly 40, each of the hardware components is also aligned along the map pocket component 32. Thus, when the door module assembly 40 is mounted to the inner sheet metal layer 16, each of the hardware components is correctly oriented relative to the rest of the door 10.

In addition, after the door module assembly 40 has been assembled (and before mounting of the door module assembly 40 to the inner sheet metal layer 16), each of the hardware components may be individually tested for operational use. As a result, when the door module assembly 40 is secured to the structural door body 12 by the OEM, operability of the each of the hardware components is ensured.

Referring to FIG. 4, access holes 42 are formed in the inner sheet metal layer 16 for receiving the door module assembly 40. Any existing motor vehicle door may be easily modified for receiving the door module assembly 40 by forming the access holes by conventional means, such as stamping. It can be seen that two access holes 42 are formed, each having an irregular shape. It will be appreciated that both the number of access holes 42 and the shape of the access holes 42 may vary depending upon specific needs.

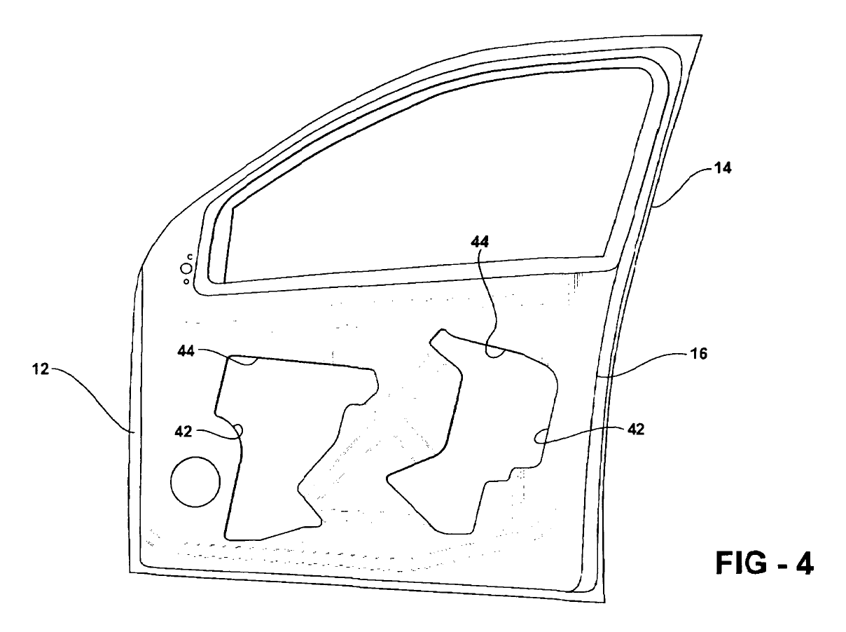

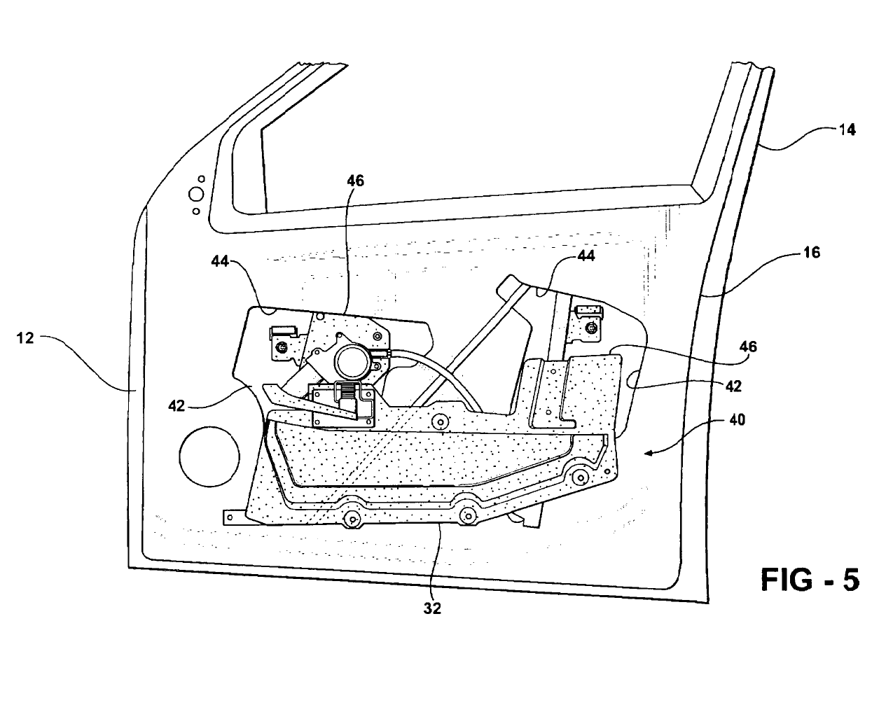

Referring to FIG. 5, the door module assembly 40 is at least partially inserted into the access holes 42 to secure the door module assembly 40 to the inner sheet metal layer 16. The door module assembly 40 may be secured to the inner sheet metal layer 16 by any conventional fasteners, such as bolts, screws, and the like. In the preferred embodiment, after the door module assembly 40 is mounted within the access holes 42, a top portion 44 of each of the access holes 42 above and outside of an upper surface 46 of the map pocket component 32 remains exposed. An individual servicing the hardware components may reach through the top portions 44 of the access holes 42 to gain access to the plurality of hardware components. Consequently, many servicing jobs may be completed without disrupting or dismantling the door construction, resulting in greater integrity of construction following servicing.

To complete assembly of the door 10, the trim panel 28, shown in FIG. 6, is then mounted over the inner sheet metal layer 16 such that an inner surface 48 of the trim panel 28 faces the inner sheet metal layer 16. The trim panel 28 overlays the door module assembly 40. Map pocket opening 29 aligns with the upper edge of the map pocket wall 38. Together, the trim panel 28 and the map pocket component 32 cooperate to define a map pocket.

A method for assembling the motor vehicle door 10 begins with securing each of the plurality of hardware components, including the inside release handle 18, the inside release cable 20, the power actuator and lock assembly 22, the window regulator 24, and the wiring harness 26, to the secondary trim component 30 to form the door module assembly 40. The secondary trim component 30 is formed separately from the trim panel 28. During attachment of the hardware components to the secondary trim component 30, the hardware components are aligned therealong so that the hardware components are properly oriented after complete assembly of the door 10. The access holes 42 are formed in the inner sheet metal layer 16 by stamping or other conventional methods. The door module assembly 40 is then at least partially inserted into the access holes 42 of the inner sheet metal layer 16 for mounting to the structural door body 12. The trim panel 28 is then secured over the door module assembly 40 to complete assembly of the door 10. If servicing of any of the hardware components is required, the trim panel 28 may be detached from the inner sheet metal layer 16 to expose the door module assembly 40, which is still mounted to the inner sheet metal layer 16. Access to the hardware components may be gained by reaching through the top portions 44 of the access holes 42, thus obviating the need for further disassembly of the door 10.

In another method for assembling the motor vehicle door 10, the method begins with securing each of the plurality of hardware components, including the inside release handle 18, the inside release cable 20, the power actuator and lock assembly 22, the window regulator 24, and the wiring harness 26, to the map pocket component 32. The map pocket component 32 is formed separately from the trim panel 28. During attachment of the hardware components to the map pocket component 32, the hardware components are aligned therealong so that the hardware components are properly oriented after complete assembly of the door 10. The access holes 42 are formed in the inner sheet metal layer 16 by stamping or other conventional methods. The door module assembly 40 is then at least partially inserted into the access holes 42 of the inner sheet metal layer 16 for mounting to the structural door body 12. The trim panel 28 is then secured over the door module assembly 40 to complete assembly of the door 10. If servicing of any of the hardware components is required, the trim panel 28 may be detached from the inner sheet metal layer 16 to expose the door module assembly 40, which is still mounted to the inner sheet metal layer 16. Access to the hardware components may be gained by reaching through the access holes 42, thus obviating the need for further disassembly of the door 10.

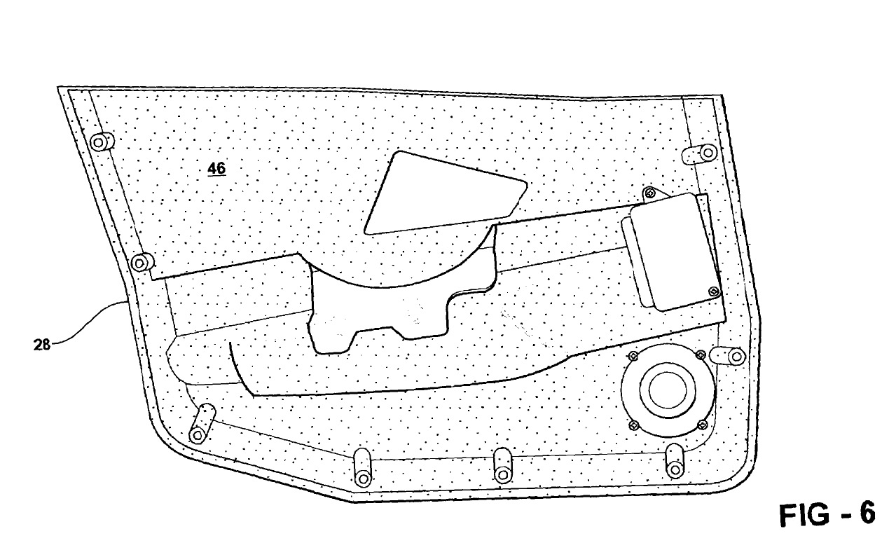

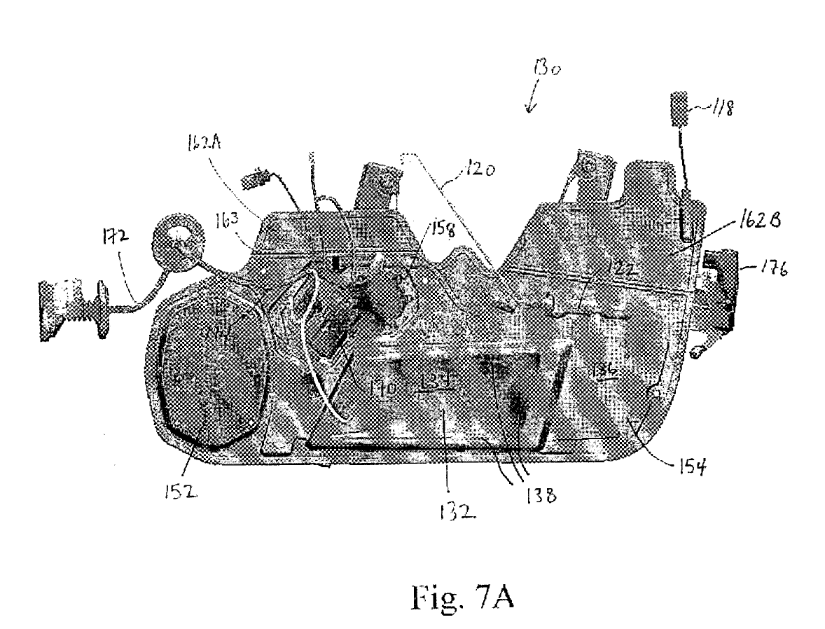

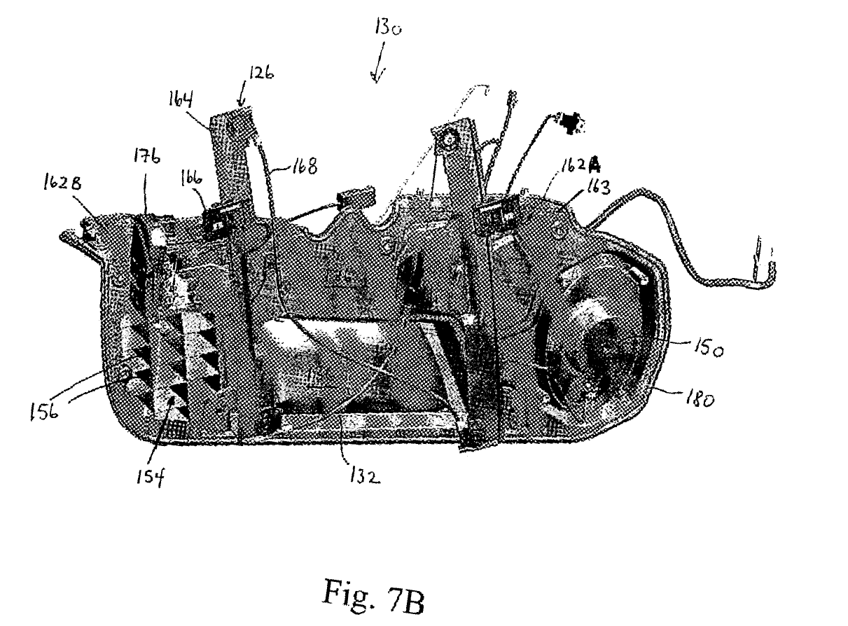

A more sophisticated embodiment of the invention is shown in FIGS. 7-18. As seen in FIGS. 7A and 7B, the secondary trim component of this embodiment, designated generally by ref. no. 130, includes a number of additional integrally molded or formed components in addition to a map pocket component 132. These additional components include: a speaker housing 150 and cover shroud 152; a side impact energy absorption structure 154, comprising a lattice of integrally molded ribs 156 preferably formed from structural plastic, as known in the art per se; a motor and cable drum mount 158; a latch presenter rail 160, seen best in FIG. ______; and at least one flap 162 provided by “living” hinge 163, the illustrated embodiment having two such flaps 162A and 162B.

The map pocket component 132 of this embodiment includes a finished or visually pleasing “class A” surface 134 that is preferably consistent with the design theme used for the interior trim panels (described in greater detail below). A U-shaped pocket wall or shelf structure 138 is formed along the finished surface 134. The remaining surface area 136 is not observable from the interior passenger compartment when the secondary trim component 130 is installed and so can have a non-finished surface to which a variety of hardware components are attached. The secondary trim component provides sufficient structural integrity to mount these hardware components for transport from a secondary assembly plant, as described in greater detail below.

The secondary trim component 130 carries all of the hardware components required for the typical vehicle door. These include:

a window regulator, generally designated by ref. no. 126, which includes one or more rails 164, lift plates 166 and interconnecting drive system 168 including motor and cable drum 170;

a wiring harness 172, which is attached to the secondary trim component 130 via integrally formed clips 174;

a lock assembly 118;

an inside release handle 122 and, in the illustrated embodiment, inside release rod 120;

a speaker (not shown); and

a latch 176;

In addition, the secondary latch component 130 carries a water-sealing bead 180 around the perimeter thereof. A robot preferably applies the sealing bead 180, as known in the art per se. In the alternative, the seal can be an integrally formed part resulting, for example, from a foam co-injection process as known in the art. As another alternative, the seal can be a separately formed part that is friction-fitted into a detent formed around the outer perimeter of the secondary latch component 130. However provided, the sealing bead 180 engages the inner sheet metal layer of the door structure when the former is installed on the latter as described in greater detail below. The secondary trim module thus provides a water shielding function, insulating the inner trim components and interior of the vehicle from the exterior environment. Consequently, the motor 170 is installed on the dry side of the secondary trim component with only the gearbox output shaft extending into the wet side, and all of the electrical connections to the motor 170 and other electrical components are carried or made on the dry side.

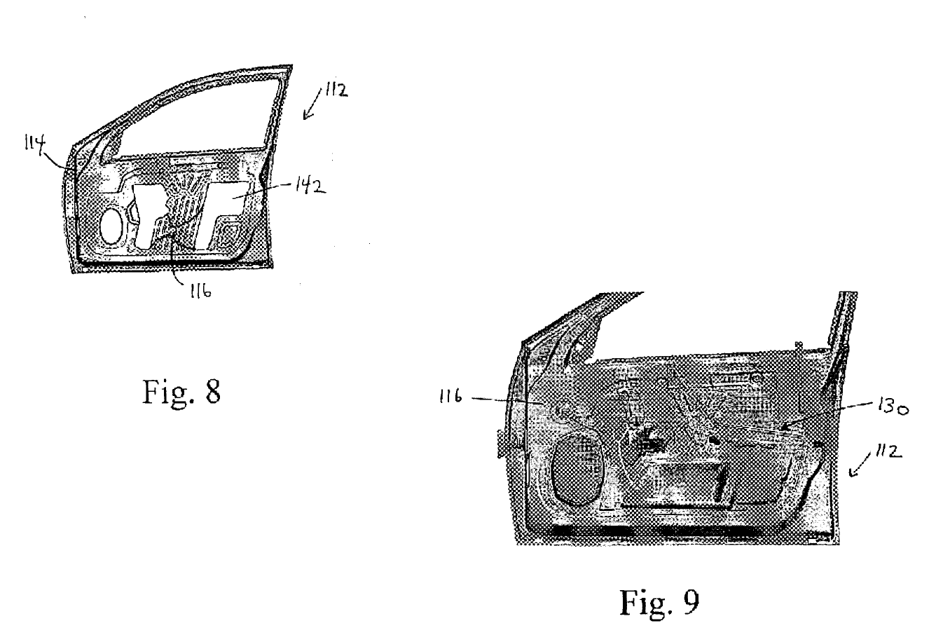

FIG. 8 shows an example of a structural door body 112 having inner 116 and outer 114 sheet metal layers to which the secondary trim component 130 is mounted. Note that in this embodiment, access holes 142 in the inner sheet metal layer 116 will be covered up by the secondary trim component when it is installed to the door body 112 as shown in FIG. 9 and discussed in greater detail below. However, since the secondary trim component 130 includes at least one moveable flap 162, the interior space between the inner and outer sheet metal layers of the door body 112 can still be accessed to mount the hardware to the inner sheet metal layer 116 or to otherwise access hardware components disposed therein.

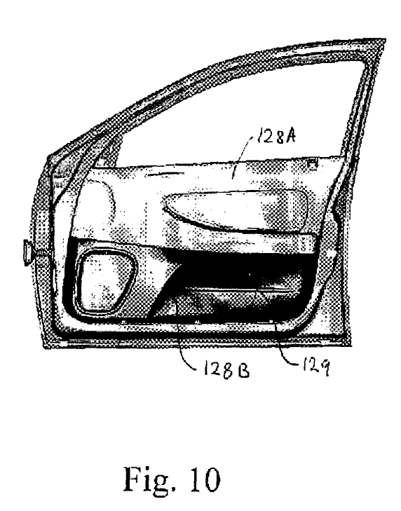

As seen in FIG. 10, the interior trim in this embodiment is provided by separate upper 128A and lower 128B panels that are co-operatively installed onto the vehicle door body 112, over the secondary trim component 130. The lower trim panel 128B has a map pocket opening 129 which aligns with the upper edge of the map pocket wall 138 on the secondary trim component 130, thus cooperatively defining a map pocket.

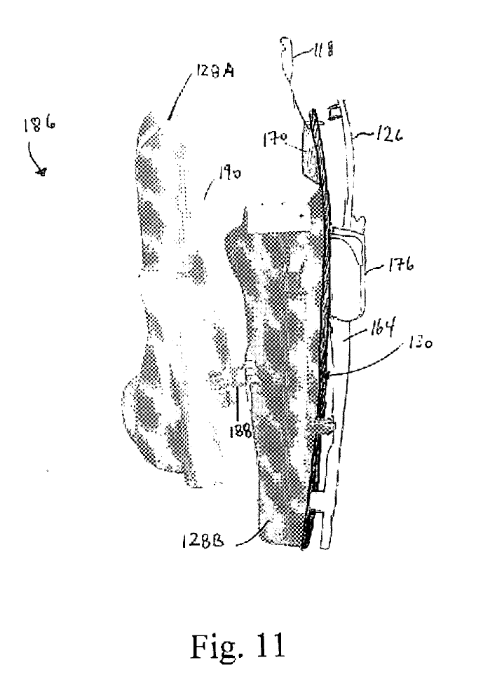

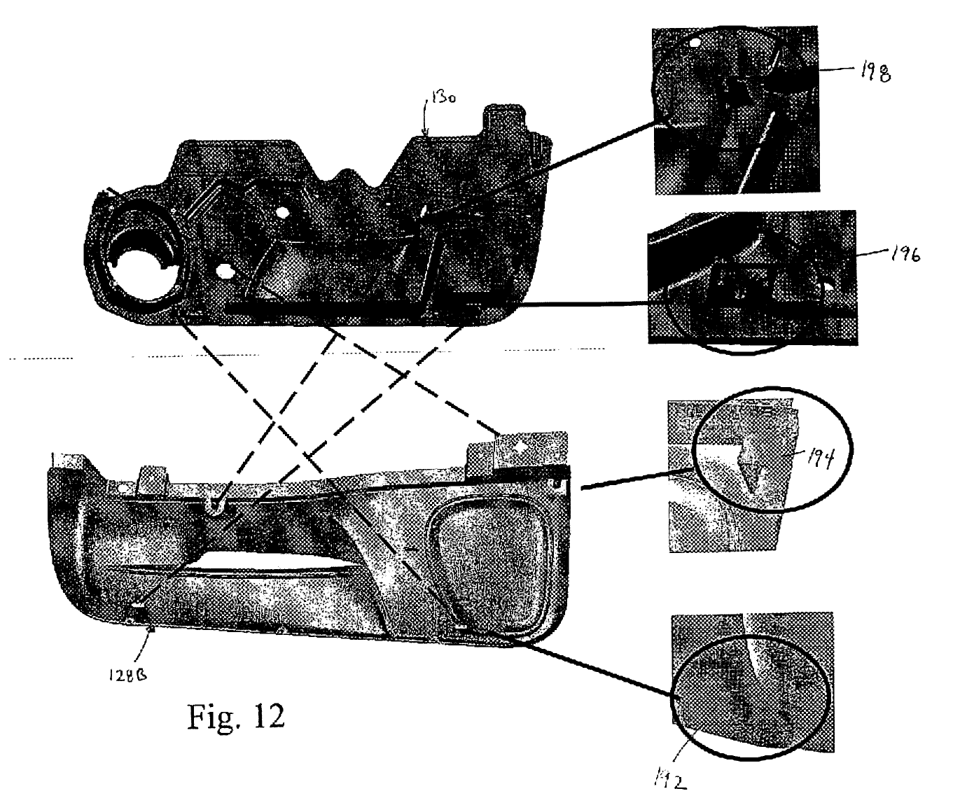

As seen best in FIG. 11, the secondary trim component (including accompanying door hardware) 130, the upper trim panel 128A and the lower trim panel 128B are provided as a single unit 186 for transport to an OEM from a secondary assembly plant. This architecture also minimizes handling and assembly operations, as described in greater detail below. The transport unit 186 includes a releasable bracket 188 and books 190 for temporarily stacking the upper trim panel 128A on the lower trim panel 128B. The lower trim panel 128B, in turn, is releasably stacked against the secondary trim component 130 by a friction-fit interconnect structure. More specifically, as seen in FIG. 12, the lower trim panel 128B includes integrally formed shipping clips or hooks 192 and pockets 194 on the rear face thereof, and the secondary trim component 130 has corresponding integrally formed pockets 196 and hooks 198 on the front face thereof. The hooks 192 on the lower trim panel 128B mate with corresponding pockets 196 on the secondary trim component 130 and the hooks 198 on the secondary trim component 130 mate with corresponding pockets 194 on the lower trim panel 128B (as schematically indicated by the stippled lines). When stacked in this manner, the lower trim panel 128B is preferably offset against the secondary trim component 130 so that the two parts may be easily separated.

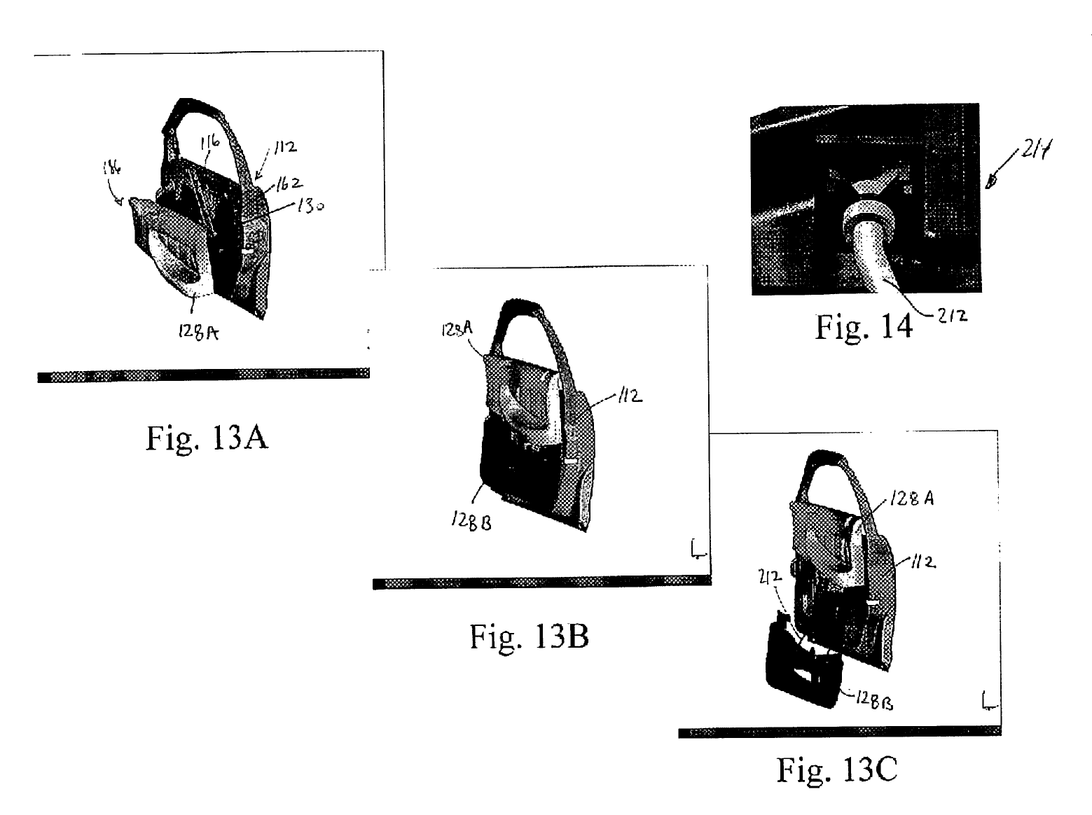

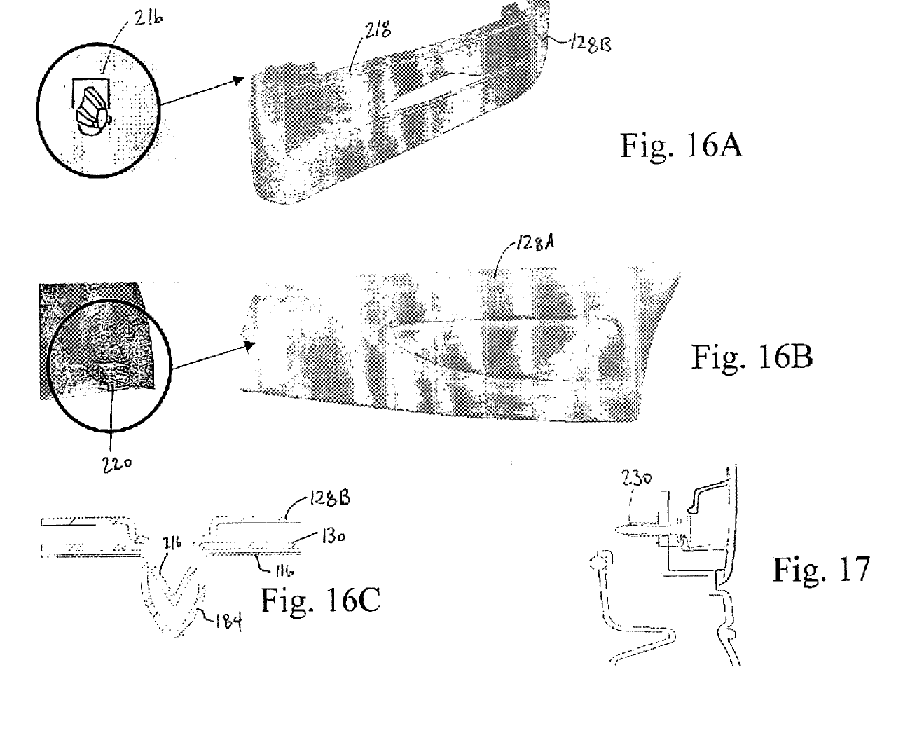

The preferred door assembly sequence is as follows: Referring to FIG. 13A, the transport unit 186 is brought adjacent the door body 112 and the secondary trim component 130 is located against the inner sheet metal layer 116. The secondary trim component has integrally molded tubules 184 projecting from the rear side thereof which are designed to be inserted into corresponding holes in the sheet metal. (See the partial cross-sectional view of FIG. 16C). In the process, the hardware located on the secondary trim component 130 is inserted at least partially into the access holes 142. The hardware is then be secured to the inner sheet metal layer 116 by conventional fasteners such as bolts and screws, and the like. The flaps 162 on the secondary trim component 130 may be utilized to gain access to the hardware located on the upper portion of the secondary trim component 130.

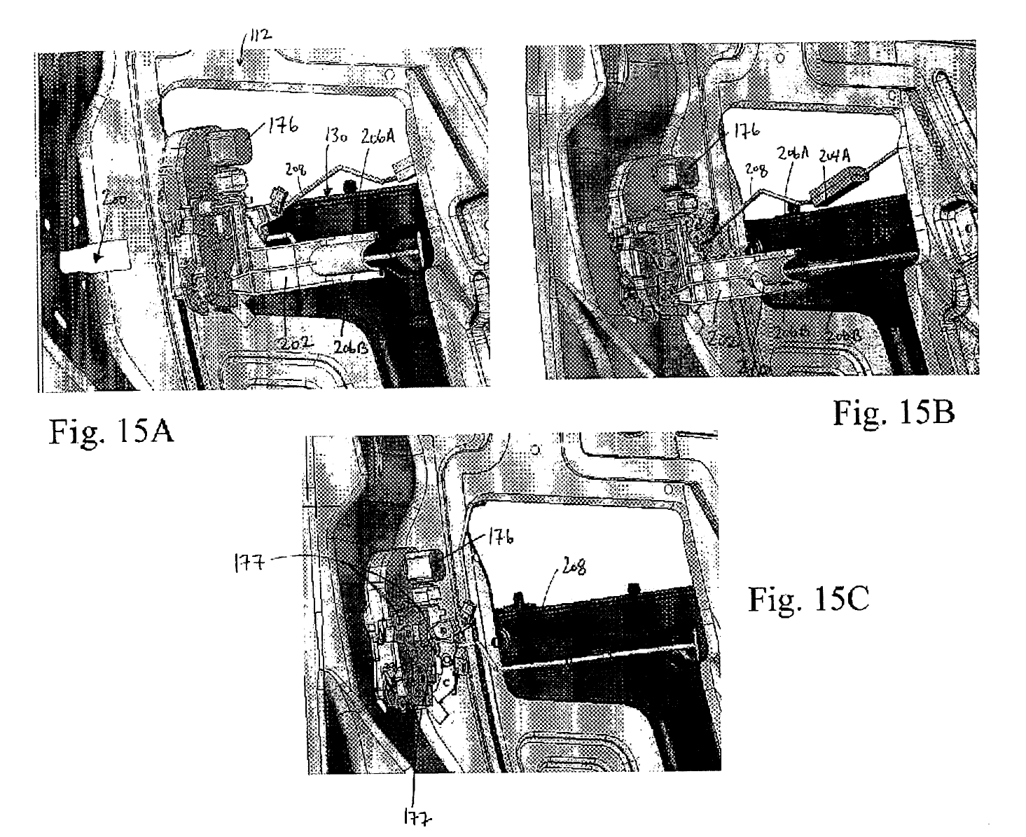

In the preferred embodiment the latch 176 is installed into an opening 200 of the door body 112, as seen best in the detail perspective views of FIGS. 15A-C. In order to ease assembly, the latch 176 is preferably temporarily mounted on a presenter 202 that is slidable on the secondary trim component 130 between an initial, park position, seen in FIG. 15A, and an installed position, seen in FIG. 15C. In order to support this function, the secondary trim component includes two integrally molded rails 204A, 204B. The presenter 202 includes two C-shaped channels 206A, 206B in its peripheral wall that glide on the rails 204A, 204B. The presenter 202 also includes one or more projecting pins (not explicitly shown) which support the latch 176 via bolt holes 177. Articulated rods 208 are used to connect the latch to other components such as the door handle. To mount the latch 176 against the door body, the presenter 202 is slid from the park position to the install position, where the latch is disposed and properly oriented adjacent the opening 200 in the door body 112. As the bolts are inserted into the boltholes of the latch, the support pins and hence the presenter are backed out of the bolt holes, enabling the presenter 202 to be easily removed from the latch 176. In addition, as one of the integral rails 204B is shorter in length than the other rail 204A, the presenter 202 may be removed from the secondary trim component 130 by an appropriate twisting motion, as symbolically represented by arrow 210.

Once the hardware on the upper part of the secondary trim component 130 is secured to the door body 12, the upper trim panel 128A is removed from the transport unit 186. The hook 190 may be used to temporarily hang the upper trim panel 128A on the door body 112 in a position higher than the installed position, as seen in FIG. 13B.

Next, as shown in FIG. 13C, the lower trim panel 128B is removed from the secondary trim component 130 by releasing the shipping clips. If desired, one or more removable straps 212 may be used to interconnect the lower trim panel 128B with the secondary trim component 130 in order to hang the lower trim panel from the door body 112 in an out-of-the-way position, leaving access to the lower portion of the secondary trim component. (FIG. 14 shows one example of an interconnect structure 214 for securing a removable strap to a part.) The hardware components located on the lower portion of the secondary trim component may then be secured to the inner sheet metal layer using conventional fasteners.

The straps 212, if employed, are then removed, and the lower trim panel 128B is located in a pre-configured orientation against the secondary trim component 130. For this purpose the lower trim panel 128B preferably includes a series of integrally molded, keyed tubules 216 (shown in FIG. 16A) projecting from the rear side thereof which mate with slightly larger correspondingly-shaped tubules 184 in the secondary trim panel and/or holes formed in the inner sheet metal layer. See also the partial cross-sectional view of FIG. 16C. Each tubule/hole combination has a different key pattern, thus eliminating position errors. Once located, the lower trim panel can then be secured to the inner sheet metal layer as known in the art per se. For example, the lower trim panel may include integrally molded clips or snap fasteners projecting from the rear side thereof for mating engagement in corresponding holes formed in the inner sheet metal layer.

Next, the upper trim panel 128A is located in a pre-configured orientation against the door body 112. More particularly, the lower trim panel 128B preferably includes a flange 218 having one or more of the locating tubules 216 thereon which will be covered from view by the upper trim panel 128A. The upper trim panel 128A preferably includes somewhat smaller locating tubules 220 on the rear side of its lower perimeter for co-locating the upper trim panel against the now-installed lower trim panel by insertion of the smaller tubules 220 into the larger tubule 216. Once located, the upper trim panel 128A is then secured to the inner sheet metal layer 116 using, for example, integrally molded clips or snap fasteners projecting from the rear side thereof which matingly engage corresponding holes formed in the inner sheet metal layer. The upper trim panel is also preferably secured to the lower trim panel at the overlapped flange 218 using clips such as clips 230 shown in the detailed sectional view of FIG. 17. The assembled door is shown in FIG. 10.

Once assembled, the hardware components can typically be serviced by removing only the upper trim panel to thus expose the flaps of the secondary trim component. These flaps may then be opened to allow access to various hardware components. For example, flap 162B can be opened to allow access to the latch 176. Advantageously, as the presenter 202 is discarded during installation, the latch can be easily removed for servicing by disconnecting the articulated rods and wiring harness.

The invention has been described in an illustrative manner. It is to be understood that the terminology, which has been used, is intended to be in the nature of words of description rather than of limitation. Many modifications and variations of the invention are possible in light of the above teachings. Therefore, the invention may be practiced other than as specifically described.

What is claimed:

1. A method for assembling a motor vehicle door having a structural door body, a plurality of hardware components, a secondary trim component, and a trim panel, the method comprising the steps of:
providing said trim panel with a map pocket opening;
providing said secondary trim component with a map pocket wall;
affixing the plurality of hardware components to the secondary trim component to form a door module assembly;
installing the door module assembly to the structural door body;
securing the trim panel to the structural door body overlaying the door module assembly, said trim panel cooperating with the secondary trim component to define a map pocket.

2. A method as set forth in claim 1 including the step of forming access holes in the structural door body prior to the step of installing the door module assembly to the structural door body.

3. A method as set forth in claim 2 wherein the installing step includes at least partially inserting the door module assembly into the access holes of the structural door body.

4. A method as set forth in claim 3 wherein the affixing step includes aligning each of the plurality of hardware components along the secondary trim component for orientation relative to the structural door body.

5. A method as set forth in claim 4 including the step of removing the trim panel from the structural door body to expose a portion of the access holes for accessing one of the plurality of hardware components secured to the structural door body.

6. A method for assembling a motor vehicle door having a structural door body, a plurality of hardware components, a map pocket component, and a trim panel, the method comprising the steps of:
affixing the plurality of hardware components to the map pocket component to form a door module assembly;
installing the door module assembly to the structural door body; and
securing the trim panel to the structural door body overlaying the door module assembly.

7. A method as set forth in claim 6 including the step of forming the access holes in the structural door body prior to the step of installing the door module assembly to the structural door body.

8. A method as set forth in claim 7 wherein the installing step includes at least partially inserting the door module assembly into the access holes of the structural door body.

9. A method as set forth in claim 8 wherein the affixing step includes aligning each of the plurality of hardware components along the map pocket component for orientation relative to the structural door body.

10. A method as set forth in claim 9 including the step of removing the trim panel from the structural door body to expose a portion of the access holes for accessing one of the plurality of hardware components secured to the structural door body.

11. A door module comprising
a trim panel having a map pocket opening;
a secondary trim component having a map pocket wall;
a plurality of door hardware components affixed to the secondary trim component;
said trim panel cooperating with the secondary trim component to define a map pocket when the trim panel overlays said secondary trim component.

12. The door module according to claim 11, wherein the secondary trim component is formed from molded plastic.

13. The door module according to claim 12, wherein the secondary trim component includes an integrated speaker housing.

14. The door module according to claim 12, wherein the secondary trim component includes an integrated energy absorbing structure.

15. The door module according to claim 12, wherein the secondary trim component includes a sealing bead around the perimeter thereof for sealing the component against a door structure, whereby one side of the secondary trim component is waterproofed.

16. The door module according to claim 15, wherein the secondary trim component includes a mount for mounting a window regulator motor on the waterproofed side of the secondary trim component.

17. The door module according to claim 12, wherein the secondary trim component includes at least one integral hinge disposed so as to create a moveable flap in the secondary trim component.

18. The door module according to claim 12, wherein the secondary trim component includes integrated rails for releasably mounting a latch presenter having guide channels slideable on the rail.

19. The door module according to claim 18, wherein one rail is shorter in length than the other.

20. The door module according to claim 11, wherein the secondary trim component and the trim panel each have parts of an interconnect structure for temporarily stacking the trim panel against the secondary trim component for shipping.

21. The door module according to claim 11, wherein the trim panel is provided in upper and lower sections, the lower section having said map pocket opening.

22. The door module according to claim 21, wherein the secondary trim component and the upper and lower trim panel sections each have parts of an interconnect structure for temporarily stacking the upper trim panel section against the lower trim panel section and the lower trim panel section against the secondary trim component for shipping.

23. A method for assembling a motor vehicle door having a structural door body, a plurality of hardware components, a secondary trim component, and a trim panel, the method comprising:
providing the trim panel with a finished surface intended to be observed from a passenger compartment, the finished surface having an opening therein;
providing the secondary trim component wherein one side thereof has a finished surface area portion, the secondary trim component having a plurality of hardware components affixed thereto at locations other than the finished surface area portion;
removeably attaching the trim panel against the secondary trim component, to thereby provide a unitized handling assembly;
securing a portion of the handling assembly to the structural door body;
removing the trim panel from the handling assembly, overlaying the trim panel in a pre-configured orientation over the secondary trim component and securing the trim panel to the structural door body, said trim panel cooperating with the secondary trim component such that the finished surface area of the secondary trim component covers the opening in the trim panel.

24. The method according to claim 23, wherein the opening in the trim panel defines a map pocket opening and wherein the finished surface area of the secondary trim component defines a map pocket wall.

25. A method for assembling a motor vehicle door having a structural door body, a plurality of hardware components, a secondary trim component, and a trim panel provided in upper and lower sections, the method comprising:
providing each of the upper and lowers sections of the trim panel with a finished surface intended to be observed from a passenger compartment, at least one of the panels having an opening therein;
providing the secondary trim component wherein one side thereof has a finished surface area portion, the secondary trim component having a plurality of hardware components affixed thereto at locations other than the finished surface area portion;
removeably attaching the upper trim panel section, the lower trim panel section and the secondary trim component against one another to thereby provide a unitized handling assembly;
securing a portion of the handling assembly to the structural door body;
removing the upper and lower trim panel sections from the handling assembly, securing any remaining hardware to the structural door body;
overlaying the lower and upper trim panel sections in pre-configured orientation over the secondary trim component and securing the trim panels to the structural door body, the trim panel section having said opening cooperating with the secondary trim component such that the finished surface area of the secondary trim component covers the opening in the trim panel.

26. The method according to claim 25, wherein the lower trim panel section has said opening which defines a map pocket opening and wherein the finished surface area of the secondary trim component defines a map pocket wall.
